(19) United States
(12) Patent Application Publication
(10) Pub. No.: US 2013/0317703 A1
(43) Pub. Date: Nov. 28, 2013

(54) PROCESS FOR SETTING THE PIVOTAL ANGLE OF THE CURVE HEADLIGHTS OF A VEHICLE

(71) Applicant: Hella KGaA Hueck & Co., Lippstadt (DE)

(72) Inventor: Boris Kubitza, Mohnesee-Korbecke (DE)

(21) Appl. No.: 13/869,584

(22) Filed: Apr. 24, 2013

(30) Foreign Application Priority Data
May 25, 2012 (DE) 102012103630.6

(51) Int. Cl. B60Q 1/076

(52) U.S. Cl. CPC B60Q 1/076
USPC 701/49

(57) ABSTRACT

A process for setting the pivotal angle of the curve headlights of a vehicle at crossroads or intersections includes the steps of defining

a projection distance for setting the pivotal angle; determining

the expected vehicle route based on at least one criterion; limiting

the projection distance when approaching a crossroad or intersection to the distance between the vehicle and the crossroad or intersection when using an expected vehicle route that involves turning at a crossroad or into an intersection; and maintaining the

projection distance without modification when using an expected route for the vehicle that does not involve turning at a crossroad or intersection.

### CROSS REFERENCE

This application claims priority to German Patent Application No. 10 2012 103630.6, filed Apr. 25, 2012, which is expressly incorporated in its entirety by reference herein.

### TECHNICAL FIELD OF THE INVENTION

The following concept pertains to the process for setting the pivotal angle of the curve headlights of a vehicle at crossroads or intersections.

### BACKGROUND OF THE INVENTION

Processes such as these for setting the pivotal angle of the curve headlights of a vehicle, particularly at crossroads or intersections, are general knowledge. They are used to provide better illumination of the area in front of the vehicle for the driver. When driving around corners, for example, a pivotal angle is generally pre-determined that adjusts the curve headlights to the radius of the curve, thereby better illuminating the road in front of the vehicle. It is also known, as described e.g. in DE 10 2008 054 005 A1, that the pivotal angle is also set at crossroads or intersections. Since crossroads or intersections represent a severe curve in the course of the road, the curve headlights are prepared for the turn at the crossroad or intersection. In the document at hand, this preparation is performed by limiting the projection distance and a corresponding predictive pivotal angle to the distance between the vehicle and the crossroad or intersection as the vehicle approaches the crossroad. By doing so, the turn made when the crossroad is reached can be performed with the best possible illumination.

The disadvantage of the known processes, particularly the process that follows DE 10 2008 054 005 A1,which is incorporated by reference herein in its entirety, is that the process is performed at every crossroad and/or at every intersection. In areas with numerous crossroads or intersections, for example when driving in the city, this can lead to inconsistent illumination of the area in front of the vehicle. In other words, the process is performed at every crossroad or at every intersection, after which the lighting returns to the standard projection distance. This leads to relatively abrupt changes in the area that is illuminated in front of the vehicle. When dealing with crossroads that are located in close proximity to one another, or in case of intersections that are close to one another, it may be impossible to determine the exact distance between the crossroad or intersection and the vehicle or it may be impossible to do so accurately. As a result, the actual pivotal angle settings vary significantly, which can even cause the lights to flicker, i.e. can cause the lights to quickly switch between the different setting angles available for the curve headlights. Drivers of the vehicle tend to find the flickering very bothersome. Furthermore, it increases the possibility of an accident in crossroad or intersection areas.

The concept at hand attempts to resolve the disadvantages described above that are related to the known process for setting the pivotal angle of the curve headlights of a vehicle, or at least to do so in part. This concept specifically focuses on a process for setting the pivotal angle of the curve headlights of a vehicle in crossroad or intersection areas that minimizes the unnecessary reduction of the projection distance.

### SUMMARY OF THE INVENTION

The task at hand is resolved using a process involving the characteristics described in claim 1. Further characteristics and the details of the concept are based on related claims, the description, and the drawings. At the same time, the characteristics and details related to the process resulting from this concept are naturally also based on the sub claims related to this concept and vice-versa, meaning that any disclosure of individual aspects of the concept will or can be referenced interactively.

A process based on this concept serves to set the pivotal angle of the curve headlights of a vehicle at crossroads or intersections. The process follows the following series of steps:
A projection distance is defined for setting the pivotal angle
The expected vehicle route is determined based on at least one criterion
When approaching a crossroad or intersection, the projection distance is limited to the distance between the vehicle and the crossroad or intersection when using an expected vehicle route that involves turning at a crossroad or into an intersection
The projection distance is not modified when using an expected route for the vehicle that does not involve turning at a crossroad or intersection.

The process developed based on this concept is selective. It allows a selection to be made as to whether the process described herein used to reduce the projection distance when approaching a crossroad should be applied or not. The selection itself is based on the probability with which the vehicle will actually turn or not. In the concept at hand, the expected route for the vehicle is mainly understood as the next segment in the route. This, in turn, is the information on whether the vehicle will turn when it reaches the cross-over point in the intersection or crossroad or whether it will continue along the main path. Naturally, any combination of two or more criteria can be used to determine the expected vehicle route. However, it should be noted that the expected route is the route the vehicle will most likely take. The criteria, or at least the single criterion used, thus serve to determine the most probably route, which itself is then used to minimize the projection distance if the vehicle is not expected to turn at the crossroad or intersection.

Reducing the projection distance when approaching a crossroad or intersection is referred to as the predictive curve light of a vehicle. The process based on this concept selectively develops this so-called predictive curve light, thereby preventing the undesirable flickering of the lights, i.e. the standard light function only switches to predictive curve light when there is a high probability that the vehicle will actually turn at the crossroad or intersection. The predictive curve light is suppressed in all other cases, thereby ensuring that the driver has a well-illuminated view of the expected route along the main road even when crossroads or intersections are approached. Moreover, unnecessary actuation or unnecessary switching operations in the inner mechanisms of the curve headlights are thereby prevented, reducing wear and increasing the life cycle of the headlights.

There are different ways to identify a crossroad or intersections. Generally, sensors are used to do so. However, camera systems, i.e. processes that provide or analyze images, could also be used to identify crossroads and/or intersections. Nature, a GPS or navigation system could also provide information on the actual street situation. That information could also be used to identify crossroads and/or intersections.

Once the vehicle has turned at an intersection or crossroad, the pivotal angle of the curve headlights is reset to the standard function. In other words, the lighting is realigned or recalibrated. Of course, the process can be repeated if another crossroad or intersection is reached in the street onto which the vehicle has just turned.

It can be advantageous to use the vehicle speed as the single criterion for determining the expected vehicle route when using the process defined based on this concept. The slower the speed of the vehicle when approaching a crossroad or intersection the higher the probability that the vehicle will turn. The criterion should preferably be a threshold value for the vehicle speed. If the vehicle slows to a speed below that threshold, it will be assumed that the vehicle is turning at the crossroad or intersection and that will be defined as the expected route. A further option would be to couple this step with a speed sensor that would identify the speed of the vehicle and thereby allow the process based on this concept to be effectively applied. This could even involve coupling the process with the vehicle's speedometer. Of course, the speed could be calculated or determined separately using a GPS system.

A further advantage can be achieved by using the vehicle acceleration as one of the criteria for determining the expected vehicle route when using the process defined based on this concept. A pre-defined threshold value is also used in this case. When the acceleration falls below the defined threshold, it will be assumed that the vehicle will turn at the intersection or crossroad and that will be used as the expected route. This threshold is generally an acceleration of zero or a negative threshold value. If the vehicle decelerates, coasting to the crossroad or if the speed is reduced by coasting or braking the vehicle, there is a very high probability that the driver intends to turn the vehicle at the crossroad or intersection. An acceleration of the vehicle can be measured or determined using an acceleration sensor. Naturally, a separate determination using a GPS system is also possible.

When using a process based on this concept, it can also be advantageous to use an activation of at least one of the light signals in the vehicle, particularly the vehicle's turn signal, as one of the criteria for determining the expected vehicle route. Of course, brake lights—as an indication that the vehicle is braking—could be used as the criterion for determining the expected vehicle route when using the light signal concept. The turn signal can also be used to predict which way the vehicle will turn when multiple turn options are available. Naturally, this method also reduces the error range when predicting the expected route, i.e. increases the probability of the calculated expected route.

Furthermore, it is also advantageous to use the route proposed by a navigation system as one of the criteria for determining the expected vehicle route when using the process defined based on this concept. If a vehicle is equipped with a navigation system, it is highly likely that the driver will follow the route proposed by the navigation system. If the proposed route includes turning at a crossroad or intersection, the likelihood that the driver will follow that proposed route is very high. In other words, the proposed route is used as the expected vehicle route in crossroad or intersection areas when using this form of the process based on this concept. Not only can this be determined directly from the current route navigation suggested for the driver, but can be determined by monitoring the preceding route. In other words, a navigation system in a vehicle can be used to monitor the preceding route of the vehicle even without active navigation assistance. The monitoring allows the probability that the driver will continue along the previous route when the next intersection is reached to be calculated. This is also referred to as the “most likely path” or MLP. A GPS sensor in the vehicle is the best way to implement the embodiment at hand.

Furthermore, the process that follows this concept can be expanded by using at least two criteria to determine the expected vehicle route, although the two criteria must be prioritized differently. The embodiments described in the following can involve a combination of these two or multiple criteria. A testing order must be defined. This is especially important for defining the priorities, for example to ensure more meaningful criteria are tested first. Such as, for example, the detection of a turn signal or a comparison to the route proposed by the navigation system. Less meaningful criteria, such as a comparison to a speed value or an acceleration value, are then tested. As soon as one of those criteria leads to the conclusion that the expected route is a turn at a crossroad or intersection, the expected route is adjusted accordingly. If ambiguous, i.e. if two criteria contradict one other, the prioritization of the criteria can be used to determine the expected route or, to be on the safe side, if a single criterion predicts a turn, the expected route can be set as a turn at the crossroad or intersection. If unclear, the process based on this concept will assume that the driver intends to turn. The prioritization accelerates the determination, as only one test has to be performed. Moreover, this method can increase the accuracy of a process based on this concept.

When using a process based on this concept it can also be advantageous to compare the actual route to the pre-determined expected route when a crossroad or intersection is passed; the agreement or difference between the two routes is then saved for a subsequent execution of the process. In other words, there is a certain learning process that is based on inaccurate interpretations. The process is thus in a position to use the difference between the expected route and the actual route to ascertain that the expected route was based on a probability that was too low.

The process described herein can be expanded by modifying at least one of the criteria used to determine the expected route, preferably a criterion threshold value, when there is difference between the pre-determined expected route and the actual route. If, for example, the vehicle speed and/or acceleration is used as the criterion, the speed or acceleration threshold value can be changed or adjusted. The learning process from inaccurate interpretations is an ongoing process, thereby increasing the accuracy of the expected route the longer the process is used. Moreover, this form of teaching the system from inaccurate interpretations can also be done in correlation with driver detection, thereby allowing the process to be personalized, i.e. performed in a driver-specific manner.

The process based on this concept should, preferably, be designed so that the pivotal angle of the curve headlights of the vehicle is used for at least one of the following light functions:
Low beam light
High beam light
Fog lights

However, the process is specifically used for the main lighting functions, namely the vehicle's low beam and high beam lights. The recommended approach is to define an illumination area in front of the vehicle for each of these light functions, an area that can be modified by pivoting.

Furthermore, a process based on this concept can be expanded by performing at least one of the following steps when the expected vehicle route involves turning at a crossroad or intersection:
The projection distance is limited to a given value when exiting or moving away from the crossroad or intersection
The course of the road is determined using a digital street map and/or based on information from a camera system
A point located in the center of the lane within the projection distance is determined based on the position of the vehicle and on the course of the road in front of the vehicle
The pivotal angle is calculated as the angle between the longitudinal vehicle axis and a line from the vehicle to the point in the middle of the lane in the projection distance
The pivotal angle is set on the curve headlights of the vehicle.

The following describes the individual steps of the process in order to better demonstrate the process based on this concept.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 A view of a vehicle approaching two intersections from above

FIG. 2 One execution of a flow diagram for a process that follows this concept

FIG. 3 One embodiment of the process based on this concept, viewed from above

FIG. 4a A vehicle approaching an intersection, and

FIG. 4b A vehicle when the intersection is reached.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

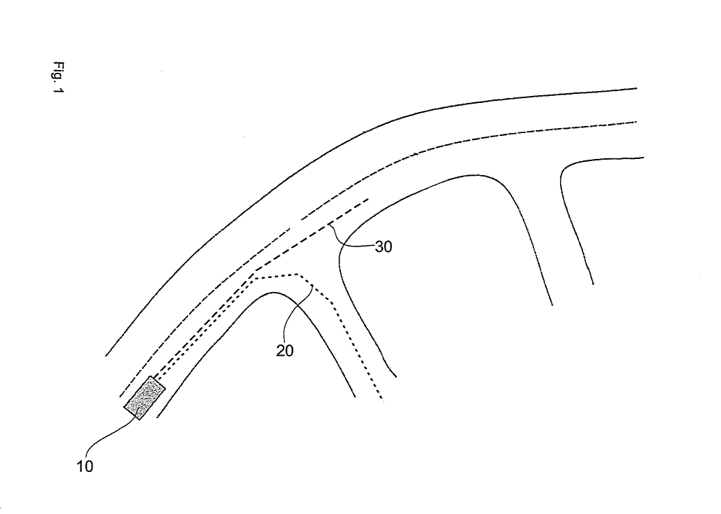

FIG. 1 shows the basic situation of a vehicle 10 with a view from above. Vehicle 10 is located on a main road and is approaching two intersections. The first dashed line indicates the expected route 20, which indicates the vehicle will turn at the first intersection. Expected route 20 was determined based on at least one criterion, which e. g. could be a reduced speed by vehicle 10, a negative acceleration of vehicle 10, the actuation of a turn signal by the driver of vehicle 10 or a corresponding route proposal by a navigation system in vehicle 10. However, if vehicle 10 passes the intersection and then actually follows route 30 on the main road, there will be a difference between the actual route 30 and the pre-determined expected route 20. This difference can be used to interpret the error, allowing the criteria, especially the criteria threshold values, to be adjusted based on that error.

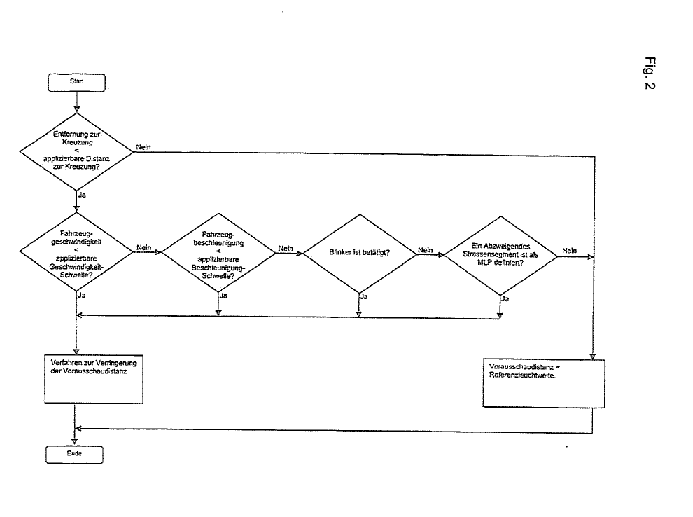

FIG. 2 shows a flow diagram of a process that follows this concept. After starting, it is determined whether there is a crossroad or intersection ahead and whether the distance to than crossroad is smaller than the applicable distance to that crossroad. Thus, the question becomes whether vehicle 10 is now close enough to the crossroad to apply the process based on this concept. If so, tests are performed on different criteria, four criteria to be specific. The tests are performed based on the priority of the criteria. The criteria are the vehicle speed, vehicle acceleration, actuation of the turn signal and the fact that a deviating segment of the road has been defined as the MLP (most likely path). With this embodiment of the process it suffices for one of these criteria to be confirmed, after which the process for reducing the projection distance based on this concept is performed. If all criteria are negated, it means there are no crossroads or intersections ahead and projection distance v is left at the reference headlight range.

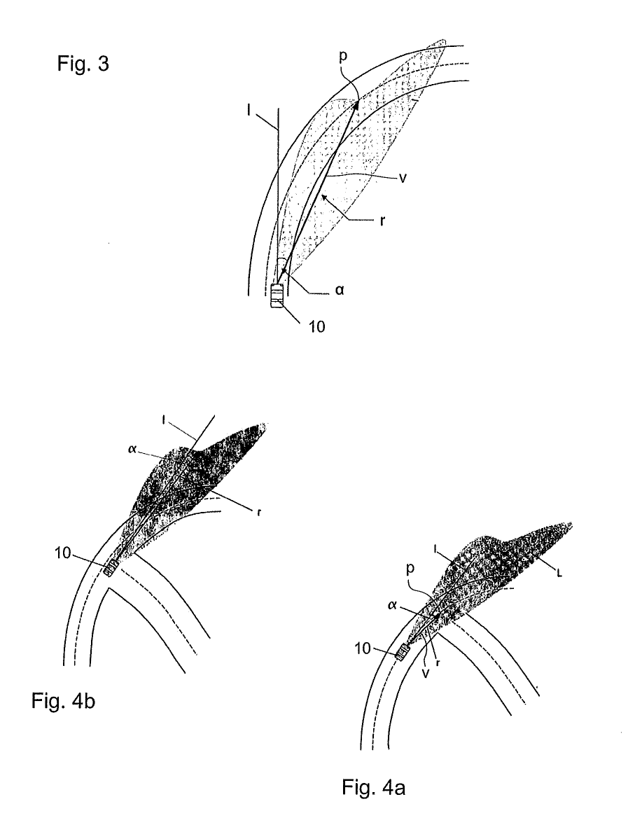

FIG. 3 briefly shows the extent to which the calculation of the pivotal angle a works based on projection distance v. For example, a projection distance v is given for the vehicle target and is followed along a straight line r from the vehicle 10 to a point p in the middle of the lane on which vehicle 10 is located. The angle between straight line r and the longitudinal axis of the vehicle 1 is pivotal angle α.

FIG. 4a shows vehicle 10 approaching an intersection. Once vehicle 10 has reached the intersection, the distance between the intersection, and thus projection distance v, is reduced.

Projection distance v is thus set to the location of the intersection. This shortens straight line r and reduces pivotal angle □. Once vehicle 10 is actually in the intersection, as shown in FIG. 4b, it either turns or continues on a straight path. At this point, projection distance v is set to zero and can either be reset for recalibration or for realignment to the standard driving light.

The following explanations of the embodiments describe the invention at hand based solely on examples. Naturally, the characteristics of the individual embodiments can be freely combined with each other, to the extent this is technically reasonable, without leaving the boundaries of the present invention.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

### REFERENCE SIGN KEY

### 10 Vehicle

20 Expected route
30 Actual route
v Projection distance
l Longitudinal vehicle axis
r Straight line
α Pivotal angle
p Point in the center of the lane

1. A process for setting a pivotal angle of one or more curve headlights of a vehicle at crossroads or intersections, comprising the steps of:
defining a projection distance for setting said pivotal angle;
determining an expected vehicle route based on at least one criterion;
limiting the projection distance when approaching a crossroad or intersection to a distance between said vehicle and a crossroad or intersection when said expected vehicle route involves turning at a crossroad or into an intersection; and
maintaining the projection distance without modification when said expected vehicle route does not involve turning at a crossroad or intersection.

2. The process according to claim 1, wherein vehicle speed is one of said criterion for determining said expected vehicle route.

3. The process according to claim 1, wherein vehicle acceleration is one of said criterion for determining said expected vehicle route.

4. The process according to claim 1, wherein activation of at least one light signal of said vehicle is one of said criterion for determining said expected vehicle route.

5. The process according to claim 1, wherein a route proposed by a navigation system in said vehicle is one of said criterion for determining said expected vehicle route.

6. The process according to claim 1, further comprising at least first and second criteria for determining said expected vehicle route, wherein said first and second criteria are assigned different priorities.

7. The process according to claim 7, further comprising the steps of determining an actual vehicle route, comparing said actual vehicle route with said expected vehicle route when a crossroad or intersection is passed, identifying points of agreement and difference between said actual vehicle route and said expected vehicle route, and saving said pointes of agreement and difference.

8. The process according to claim 7, further comprising the step wherein in the event a point of difference between said expected route and said actual route is identified, then at least one criterion, a threshold value of a criterion in particular, will be modified to determine the expected route (20).

9. The process according to claim 1, further comprising the step of using said pivotal angle for at least one of the light functions in the group consisting of a
low beam light, a
high beam light, and a
fog light.

10. The process according to claim 1, further comprising the step of limiting said projection distance to a given value when said vehicle is exiting or moving away from a crossroad or intersection when said expected vehicle route involves turning at a crossroad or an intersection.

11. The process according to claim 1, wherein activation of a turn signal of said vehicle is one of said criterion for determining said expected vehicle route.

12. The process according to claim 1, further comprising the step of determining a course of a road on which said vehicle is moving with a digital street map or from information from a vehicle camera system when said expected vehicle route involves turning at a crossroad or an intersection.

13. The process according to claim 1, further comprising the step of determining a point located in the center of a lane within said projection distance based on a position of said vehicle and on a course of a road in front of said vehicle when said expected vehicle route involves turning at a crossroad or an intersection.

14. The process according to claim 1, further comprising the step of calculating said pivotal angle as an angle between a longitudinal axis of said vehicle and a line from said vehicle to a point in a lane in said projection distance when said expected vehicle route involves turning at a crossroad or an intersection.

15. The process according to claim 1, further comprising the step of setting said pivotal angle on said curve headlight of said vehicle when said expected vehicle route involves turning at a crossroad or an intersection.
